(19) United States
(12) Patent Application Publication
(10) Pub. No.: US 2013/0084152 A1
(43) Pub. Date: Apr. 4, 2013

(54) Container Loading System

(71) Applicant: The Heil Co., Chattanooga, TN (US)

(72) Inventor: Charles A. DUELL, Fort Payne, AL (US)

(73) Assignee: THE HEIL CO., Chattanooga, TN (US)

(21) Appl. No.: 13/623,976

(22) Filed: Sep. 21, 2012

Related U.S. Application Data
(60) Provisional application No. 61/541,400, filed on Sep. 30, 2011.

(51) Int. Cl. B60P 1/00; B66D 3/00

(52) U.S. Cl. CPC B60P 1/00; B66D 3/006
USPC 414/559; 254/386

(57) ABSTRACT

A container loading system has a hoist frame with a movable carriage. A pair of single stage cylinders moves the carriage between positions. The carriage includes at least two rotatable sheave to receive a cable. The cable has a free end to attach with a container. The movement of the cylinders moves the carriage between positions to load or unload a container onto or from the container loading system.

### CROSS-REFERENCE TO RELATED APPLICATIONS

This application claims the benefit of U.S. Provisional Application No. 61/541,400, filed on Sep. 30, 2011. The entire disclosure of the above application is incorporated herein by reference.

### FIELD

The present disclosure relates to refuse collection and, more particularly, to a container loading system.

### BACKGROUND

Many businesses utilize containers for refuse collection. Ordinarily, the containers are quite large and weigh several thousand pounds. These types of containers are generally referred to as “roll off” type containers. The container utilizes rollers which mesh with a roller system on a vehicle container loading system wherein the container is hoisted along a frame, onto the frame, and then the frame is lowered and leveled on the vehicle and removed from the site. Delivery to the site is in a reverse order.

Ordinarily, the vehicles require a hoist device that includes a reaving cylinder arrangement to raise the hoist so that it can remove and deliver the container from and to the job site. Ordinarily, these hoists include a frame with a fixed pulley at the top of the hoist. Thus, the cylinders must lift the free end of the hoist frame well above the vehicle in order to lift and remove the container onto and from the frame. This requires a lift cylinder to raise the frame high above the height of the vehicle as well as a winch to retract the cable while drawing the container onto the frame.

### SUMMARY

Accordingly, it is desirable to have a low profile hoist system capable of lifting large containers. Also, it is desirable for the hoist frame, when lifting and lowering a container, to provide a faster more productive loading system.

Accordingly, the present disclosure provides the art with a vehicle having a low profile hoist frame system to pick up roll off refuse containers. The present disclosure provides a stable roll-off hoist frame with a movable sheave system that picks up and drops off containers.

According to a first aspect of the disclosure, a container loading system comprises a hoist frame with a movable carriage. The carriage is movable along the hoist frame in a track. One or more single stage hydraulic cylinders are coupled with the hoist frame and the carriage. At least two rotatable sheaves are coupled with the carriage. A cable is associated with the sheaves. The cable includes a free end to attach with the container. Additionally, the other end of the cable is secured to the hoist frame. The movement mechanism moves the carriage between positions on the hoist frame loading and unloading containers.

According to a second aspect of the disclosure, a vehicle with a container loading system comprises a vehicle with a frame, wheels and drive train. A hoist frame is coupled with the vehicle. A carriage is movable along the hoist frame in a track. One or more single stage hydraulic cylinders are coupled with the hoist frame and the carriage. At least two rotatable sheaves are coupled with the carriage. A cable is associated with the at least one sheave. The cable includes a free end to attach with the containers. The other end of the cable is secured to the hoist frame. The movement mechanism moves the carriage between positions on the hoist frame loading and unloading the containers.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle with a container loading system.

FIG. 2 is a perspective schematic view of the container loading system removed from the vehicle.

FIG. 3 is another perspective schematic view of the container loading systems removed from the vehicle.

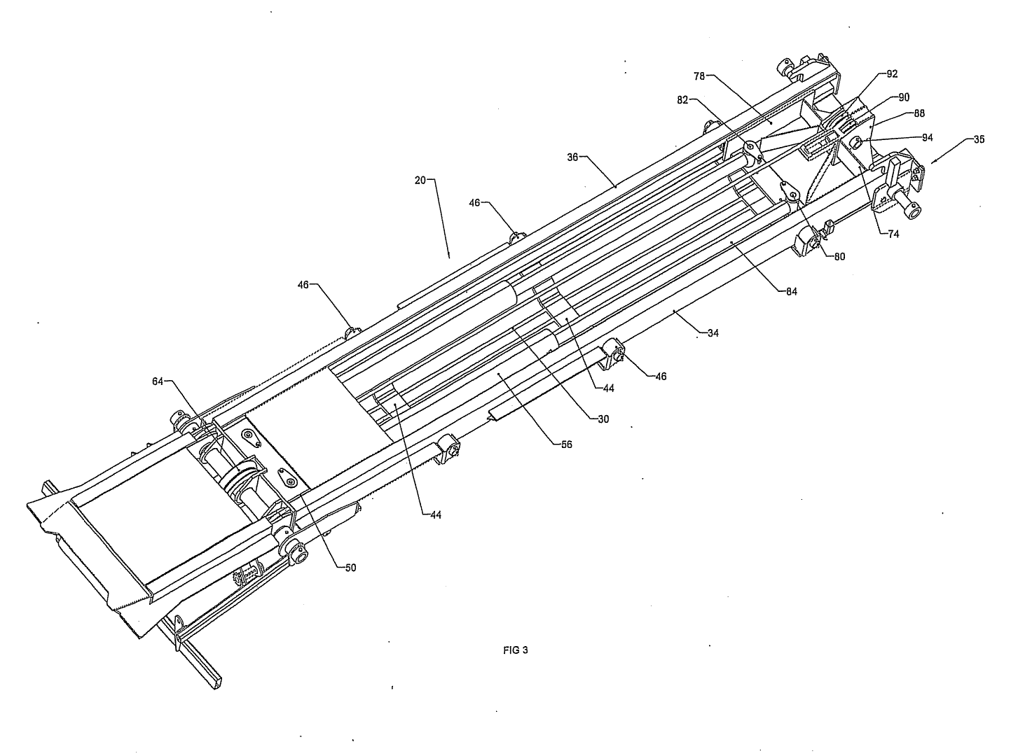

FIG. 4 is a front perspective schematic view of the container loading system removed from the vehicle.

### DETAILED DESCRIPTION

Turning to the figures, a vehicle is illustrated and designated with the reference numeral 10. The vehicle includes a frame 12 supported by wheels 14. Also, the vehicle includes a cab 16 that includes driver operation equipment. Additionally, an engine and drive train are included to drive the vehicle. Additionally, the container loading system can be mounted on a stand alone trailer that can be pulled behind a vehicle.

A container loading system 20 is coupled with the vehicle via a pair of hydraulic cylinders 21. One end of the cylinder is coupled with the frame 12 and the rod end is coupled with the free end of the hoist frame 22. The cylinders 21 lift the container loading system 20 between an unloaded position and a loaded position. In the loaded position, the cylinders 21 are collapsed and not vertical to the frame 12 with the container 32 resting on top of the container loading system 20.

The container loading system 20 includes a hoist frame 22, a tailgate assembly 24, a movable carriage 26, a mechanism 28 to move the carriage 26, and a cable 30 to connect with a container 32.

The hoist frame 22 includes a pair of beams 34, 36 positioned parallel to one another. The beams 34, 36 interior sides include slots 38, 40 to movably retain the carriage 26 on the beams 34, 36. Additionally, the hoist frame 22 includes a plurality of cross-beams 44 that connect the beams 34, 36 with one another. A channel or plurality of rollers 46 is coupled with the exterior side of the beams 34, 36. The rollers 46 enhance movement of the container 32 along the hoist frame 22. Also, the hoist frame 22 may include a shield 48 positioned along the cross-beams 44.

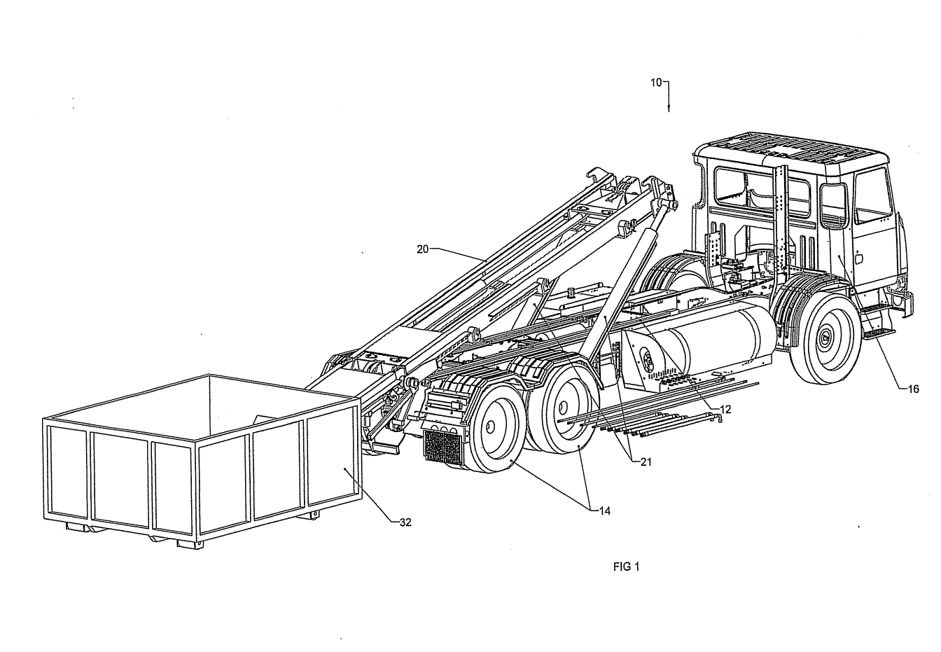

The hoist frame 22 includes a base 50 that is secured with the movement mechanism 28. The base 50 also includes a rotatable sheave 52 that receives the cable 30. The sheave 52 or pulley rotates in a clevis or yoke 54. The base 50 is pivotally connected with the frame 12. When the cylinders 21 lift the hoist frame 22 to a loading position, container off, or an unloading position, container on, as illustrated in FIG. 1, the hoist frame 22 is angled at a relatively small acute angle with respect to the ground. Thus, this angle provides the low profile hoist system capable of lifting large containers.

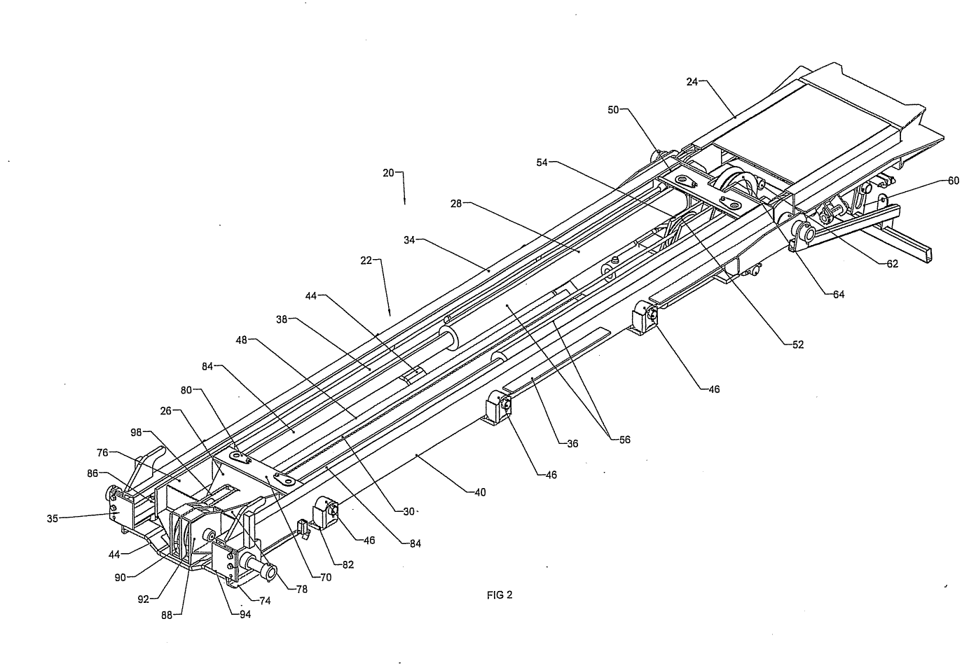

The movement mechanism 28 includes a pair of single stage hydraulic cylinders 56 connected with the base 50. The single stage hydraulic cylinders 56 are connected with a controller (not shown) that operates the cylinders 56 between an extended and retracted position as shown in FIGS. 1 and 2.

A tailgate assembly 24 is coupled with the base 50. The tailgate assembly 24 pivots up and down to enhance loading and unloading of the container 32. The tailgate assembly 24 includes a linkage 60 as well as a hydraulic cylinder 62 to move the tailgate assembly 24 between positions. Additionally, a roller 64 is coupled with the base 50 to enhance the smooth transitional movement of the cable 30 as the container is moved from position to position. Alternatively, the hoist frame 22 could be utilized without a tailgate assembly

The carriage 26 includes a pair of cross-members 70, 74 as well as a pair of side members 76, 78 providing the carriage with an overall rectangular configuration. The cross-member 70 receives pins 80, 82 that secure with the rods 84 from the single stage hydraulic cylinders 56. The side members 76, 78 include a plurality of outwardly extending pins 86 that fit into the slots 38, 40 on the interior of the beams 34, 36. This secures the carriage 26 in the slots 38, 40. Additionally, the pins 86 may include rollers to enhance the movement of the carriage 26 in the beams 34, 36. The cross-member 74 includes a sheave housing 88. The sheave housing 88 includes a pair of rotatable sheaves 90, 92. The sheaves 90, 92 are rotatable in the housing 88 about the pin 94. Thus, the pin 94 fixes the sheaves 90, 92 for rotation in the housing 88.

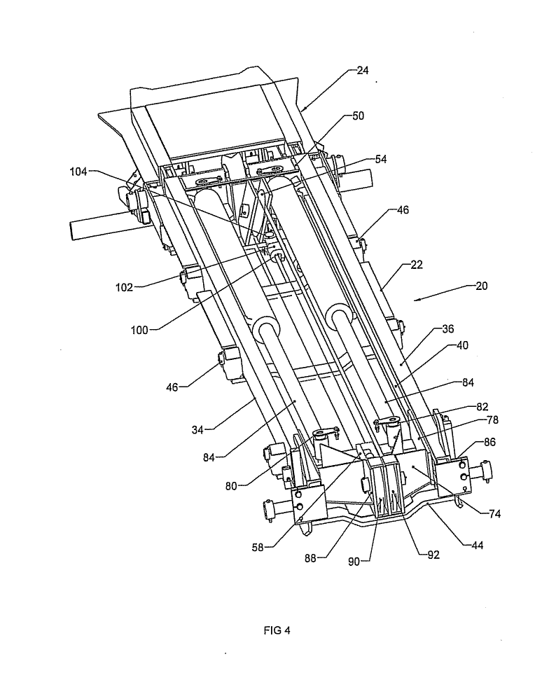

Cable 30 has one end secured to the base 50 of the hoist frame 20. The cable 30 is then, in turn, wrapped around sheave 92 back to sheave 54, wrapped around sheave 90 and passed through eyelet 98. The cable 30 has a free end 100 to secure with the container 32. The free end 100 includes a yoke member 102 with a pin 104 to secure the cable with the refuse container 32. In FIG. 4, the yoke 102 is illustrated coupled with one of the cross-members 44 in a transport position. As the carriage 26 moves, so does the cable. For each one foot traveled of the carriage, the cable moves approximately four feet. Thus, this enables rapid loading and unloading of the container 32. Also, this enables the length of the hoist frame to be shortened.

Additionally, the movement of the carriage and the cable enable shaking of the container 32 for dumping purposes. The container 32 on the hoist frame 22 is lifted by the cylinders 21 into a dumping position. The carriage 32 is rapidly released from the free end of the hoist frame 22 dropping about one foot which, in turn, drops the container about four feet. The carriage 26 is then rapidly raised back to the free end of the hoist frame. This action is repeated about three times. The rapid dropping and raising of the container 32 shakes the container 32 effectively and efficiently emptying its contents. The hoist frame is then leveled onto the vehicle.

The container loading system operates as follows:

When loading a container, the cylinders 56 are retracted into a down position as illustrated in FIG. 1. At this time, the carriage 26 is positioned along the beams 34, 36. The cable 30 free end 100, via the yoke 102 and pin 104, is secured with the container 32. Also, the tailgate assembly 24 may be positioned to initiate loading of the container 32 onto the container loading system 20. After the tailgate assembly 24 is in position and the cable 30 is connected with the container 32, the cylinders 56 are activated. As this occurs, the rods 84 are moved outward towards the free end 35 of the beams 34, 36 that are secured with cylinders 21. As this occurs, the carriage 36 moves upwardly toward the free end 35 of the beams 34, 36. Also, the cable 30, wrapped around the sheaves 52, 90, and 92, acting as a block and tackle, draws the container 32 onto the hoist frame 22. As the cylinders 56 continue to expand, the cable 30 continues to draw the container 32 upward until the container 32 is positioned onto the hoist frame 22. At that time, with the cable 30 extending through the eyelet 98, the cylinders 21 are lowered to position the container loading system 20 in a leveled condition onto the vehicle frame 12.

To remove the container 32 from the container loading system 20, the cylinders 21 are raised and the cylinders 56 are operated in a reverse fashion so that carriage 26 moves downwardly along the beams 34, 36 from the free end 35 of the beams 34, 36 to the point wherein the container 32 is positioned on the ground as illustrated in FIG. 1.

The present disclosure has been described with reference to a preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A container loading system comprising:
a hoist frame;
a carriage movably coupled with the hoist frame, the carriage moving along the frame;
at least one single stage cylinder for moving the carriage between positions, the at least one single stage cylinder coupled with the hoist frame and the carriage;
at least two sheaves on the carriage; and
a cable associated with the at least two sheaves, the cable having a free end for attaching with a container wherein the movement of the moving mechanism moves the carriage to load or unload the container onto or from the hoist frame.

2. The container loading system of claim 1, wherein a pair of single stage hydraulic cylinders move the carriage.

3. The container loading system of claim 1, wherein another end of the cable is secured to the hoist frame.

4. A refuse vehicle with a container loading system comprising:
a vehicle with a frame, wheels, and a drivetrain;
a hoist frame movably coupled with the vehicle frame;
a carriage movably coupled with the hoist frame, the carriage moving along the hoist frame;
at least one single stage cylinder for moving the carriage between positions, the at least one single stage cylinder coupled with the hoist frame and the carriage;
at least two sheaves on the carriage; and
a cable associated with the at least two sheaves, the cable having a free end for attaching with a container wherein movement of the moving mechanism moves the carriage to load or unload the container onto or from the frame.

5. The refuse vehicle of claim 4, wherein a pair of single stage hydraulic cylinders move the carriage.

6. The refuse vehicle of claim 4, wherein another end of the cable is secured to the frame.

7. A container loading system comprising:
a hoist frame;
a carriage movably coupled with the hoist frame, the carriage moving along the frame;
a pair of single stage cylinders for moving the carriage between positions, the pair of single stage cylinders coupled with the hoist frame and the carriage;
at least two sheaves on the carriage; and
a cable associated with the at least two sheaves, the cable having a free end for attaching with a container wherein the carriage rapidly moves on the hoist frame for shaking a container for emptying purposes.
